(19) United States
(12) Patent Application Publication
(10) Pub. No.: US 2008/0065717 A1
(43) Pub. Date: Mar. 13, 2008

(54) World wide web implementation enabling participants audio musical rap presentations

(75) Inventors: Isaac Momoki Berkin, (US); Alexander Roy Tucker, (US)

Correspondence Address: J. B. Kraft, 710 Colorado Street, Austin, TX, 78701, US

(73) Assignee: Entertainment Madness, Inc.

(21) Appl. No.: 11/517,922

(22) Filed: Sep. 11, 2006

(51) Int. Cl. G06F 15/16; G06F 15/173

(52) U.S. Cl. 709/203; 709/204; 709/223

(57) ABSTRACT

Enabling participants to participate in the user-interactive generation of audio musical presentations on an interactive real-time basis involving many receiving display stations or terminals on the Web. Web pages are distributed to participants at Web display stations that include presentation window space in said Web page. An implementation in the window space offers a set of audio music beats to a participant. A method includes playing one of the offered set of audio music beats to a participant, enabling the participant to input audio content, correlating the input audio content with the beat to generate a correlated audio presentation and providing an audio output of the correlated audio presentation.

### TECHNICAL FIELD

The present invention relates to computer managed communication networks, such as the World Wide Web (Web), and particularly to the interactive generation of Rap presentations at display stations or terminals and the distribution of such rap presentations to other display stations on the Web.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Because of the rapid expansion of industry and commerce telecommunication bandwidth needs over the past decade, the telecommunications industry has been rapidly expanding the worldwide infrastructure needed to satisfy these needs.

One area has been that of Internet Protocol (IP) Telecommunications wherein voice and other audio telecommunications are transmitted over the Internet or Web. In such IP telephonic communications, voice communication is broken down into voice packets that are digitized and transmitted over the Internet using IP telecommunication Protocols. The text, IP Telephony Demystified, Ken Camp, published 2003, McGraw-Hill, New York, N.Y., describes such transmission of voice packets; particularly in Chapter 3, pp. 54-69. This has become the basic Voice over IP (VOIP) primary technology used to transmit voice and audio content over the Internet or Web (these terms are used interchangeably herein). This Voice over IP technology is described in greater detail (page 870) in Newton's Telecom Dictionary, Harry Newton, 2003, CMP Books, San Francisco, Calif., as well as in the above text IP Telephony Demystified at pages 222-223.

These expanded Web resources combined with the availability of Voice over IP has led to the development of many computer applications in the field of electronic entertainment on the Web. The present invention is directed to such a development.

### SUMMARY OF THE PRESENT INVENTION

The present invention provides a system, method and computer program for enabling participants to participate in the user-interactive generation of audio musical presentations on an interactive real-time basis involving many receiving display stations or terminals on the Web. The invention is particularly effective in such presentations of rap music wherein rappers and potential rappers are given the opportunity to hone their skills before a real-time interactive Web audience, have fun, and get real-time feedback as to their abilities from the “spectators” in the Web audience. Because of the easy access to the Web, it is understood that managers and agents seeking entertainment talent can readily browse the Web. Thus, the invention offers presenters, e.g. rappers, an informal, easy, broad and inexpensive venue in which to expose their talents and abilities, and perhaps be discovered.

The invention involves distribution via the Web of Web pages to participants and Web display stations, and includes means for providing a presentation window space in said Web page, means in the window for offering a set of selectable audio music beats to a participant, means for playing one of said offered set of audio music beats to a participant, means enabling the participant to input audio content, means for correlating the input audio content with the beat to generate a correlated audio presentation, and means for providing an audio output of the correlated audio presentation.

The invention may further include means for displaying said Web page including said presentation window space to each of the participants at said display terminals, combined with means for enabling each of the participants to selectively participate in the presentation either as a presenter or as a spectator. The invention may also enable a plurality of the rap presenters to present their respective presentations in the presentation window space, in a competitive environment wherein the respective rappers are judged in head-to-head competition.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of a portion of a Web network that may be used for the interactive generation of audio music presentations in accordance with the present invention;

FIG. 2 is a block diagram of a data processing system including a central processing unit and network connections via a communications adapter that is capable of implementing the interactive display terminals, as well as servers in the Web network of this invention;

FIG. 3 is a diagrammatic illustration of an interactive display Web page interface used for generating rap presentations by individual rappers via the Web;

FIG. 4 is a display interface like that of FIG. 3 but used for competitive generation of rap sessions by two rappers;

FIG. 5 is an illustrative flowchart describing the setting up of the programming functions to form the implementation enabling the interactive generation of audio musical presentations in accordance with the present invention;

FIG. 6 is a flowchart of an illustrative run of the program set up according to FIG. 5; and

FIG. 7 is a continuation of the illustrative run of FIG. 6.

### DETAILED DESCRIPTION OF THE PREFERRED EMBODIMENT

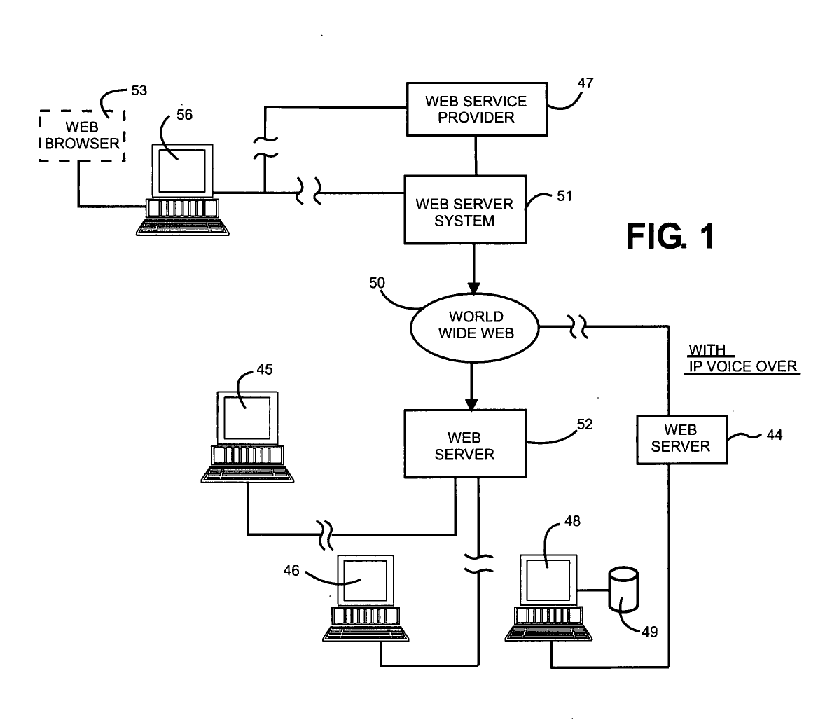

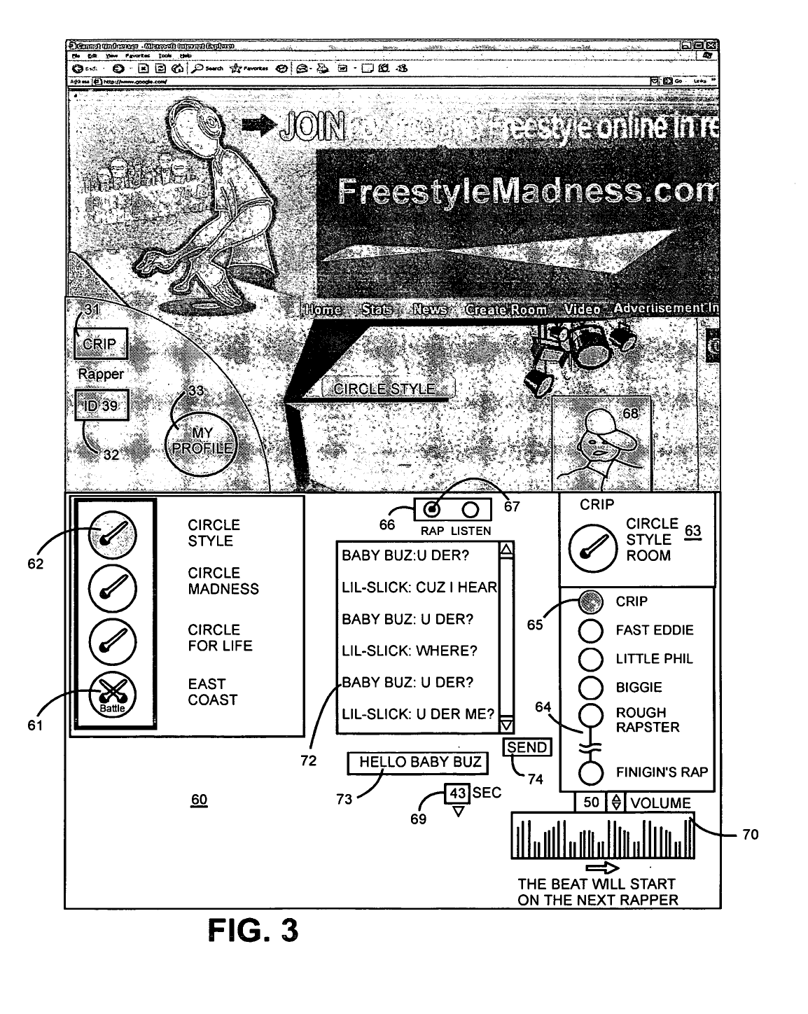

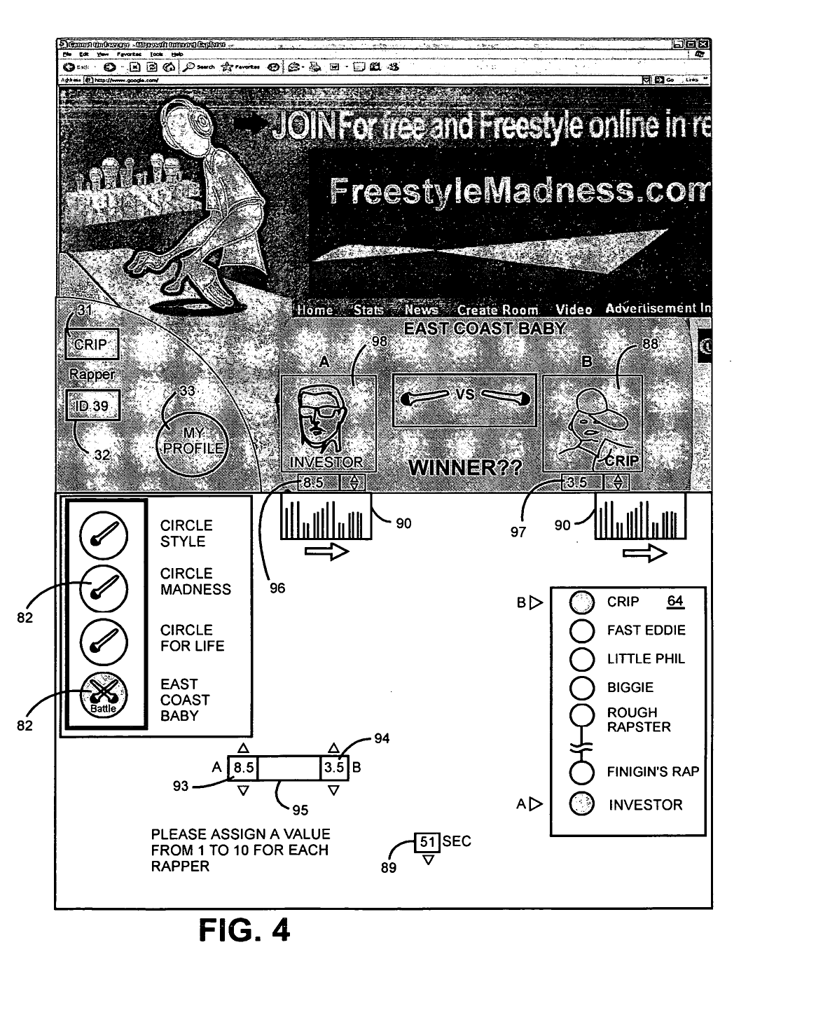

Referring to FIG. 1, a generalized diagram of a Web or Internet portion is shown to illustrate the distribution of the Web pages and the interrelationship of the participants at Web stations in the practice of the present invention. As will hereinafter be described in greater detail, each of the participants, whether rapper or spectator, is communicated with through a set of terminals or stations 45, 46 and 56. These terminals, each having a Web browser program, as illustrated by browser 53 associated with terminal 56, are connected to the Web 50 through respective Web servers 51 and 52. Alternatively, a station e.g. station 56, may be connected to the appropriate Web server 51 via a Web service provider 47. In the examples that will be subsequently described with respect to FIGS. 3 and 4, the rap beats are stored in an appropriate database 49, and the application program providing and coordinating the beats with the rapper's audio input are carried out at the Web site 48 associated with the database of beats 49 that communicates via Web server 44 connected to Web 50. The communication protocols used are conventional HTML Web pages with Voice over IP function as previously described. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. In a simple operation, appropriate Web pages are accessed by display stations 45, 46 and 56 from Web site 48 on which the Web pages are stored in database 49. As will hereinafter be described with respect to FIGS. 3 and 4, the participants at terminals may chose to be rappers or spectators. If the participants are rappers, the beats are provided from database 49 of Web site 48 using VOIP protocols to transmit the appropriate beat audio content to the user at an appropriate interactive display station, e.g. station 56. When the rapper inputs his audio/voice input, the rapper input is transmitted back to Web site 48, using the same VOIP protocols wherein the application program of the present invention correlates the beat with rapper input. The correlated beat and rapper audio input are then transmitted using the VOIP protocols back to the rapper at terminal 56, and back to any participants, e.g. as spectators at display stations 45 and 46 still using the VOIP protocols. It should be noted that where a Web service provider 47 is used, the coordination function of the present invention may be implemented in an application program at the Web service provider rather than at the Web site 48. However, the same VOIP protocols may be used in transmitting all audio input and output.

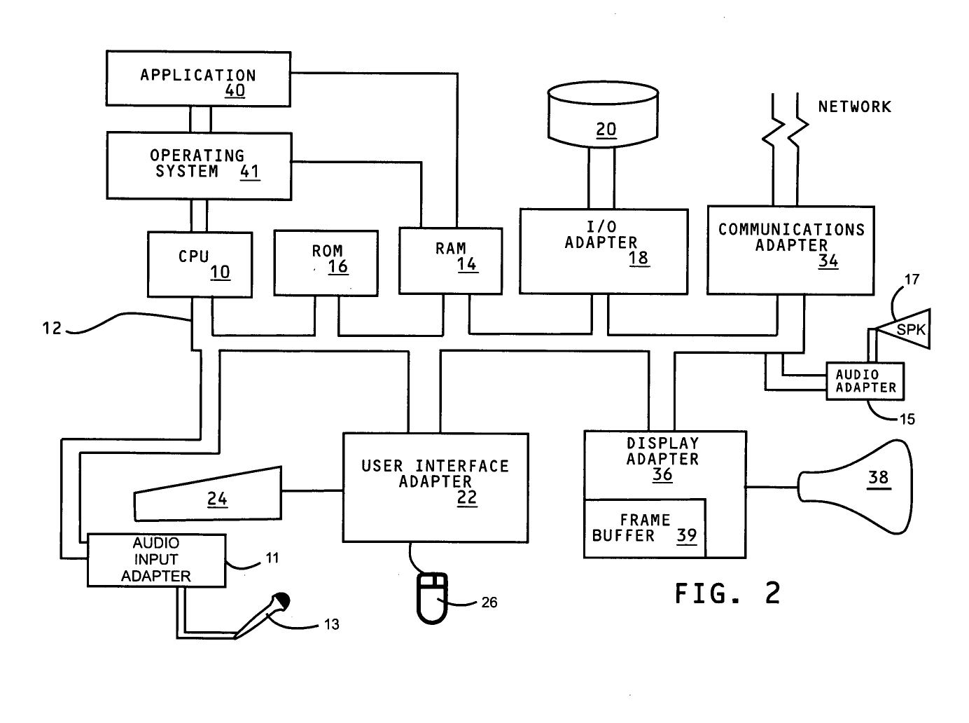

Referring to FIG. 2, a typical data processing system is shown that may function as the Web display terminals or stations used in this invention. The system shown is also illustrative of any of the Web server computers described with to FIG. 1. The basic computer shown in FIG. 2 represents a basic computer structure that may also be used to control Web site 48. A central processing unit (CPU) 10, may be one of the commercial microprocessors in personal computers available from International Business Machines Corporation (IBM) or Dell Corporation; when the system shown is used as a server computer at a network distribution site to be subsequently described, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX6000™ operating system available from IBM; Microsoft's Windows XP™ or Windows2000™, as well as UNIX and other IBM AIX operating systems. Application programs 40, controlled by the system, are moved into and out of the main memory Random Access Memory (RAM) 14. These programs include the application programs of the present invention for controlling the user interactive generation of rap music presentations when such application programs are implemented on Web site 49. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the network in order to access instant messages. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38. The composite system shown in FIG. 2 also includes the audio output of the beats or the beats coordinated with the rap input to the rapper and the audience of participants at the display stations. This audio output is through the audio adapter 15 and representative speaker 17. The rapper input may be through a microphone 13 connected via audio input adapter 11.

Within the Web network set up, we will now consider some illustrative examples of the generation of rap music presentations with respect to FIGS. 3 and 4. In FIG. 3, there is illustrated a display screen with a Web page 60 to be used for the generation of a rap music presentation. This Web page is presented to everyone who logs on to the Rap music generation session. Thus, this page is accessed from the Web site by everyone who logs on a Web display station for the rap music generation session. From the menu of possible rap session rooms 61, the user has selected “Circle Style” 62 (shown highlighted), and the “Circle Style” session commenced. In the session, everyone who logs on is given an opportunity to rap, i.e. sing or speak an audio input, in conjunction with a rap beat that is played for the rapper. In a simple session, each rapper who logs on is listed 64 and given an opportunity to rap for a set amount of time (in the illustration, one minute) that is tracked in time window 69. Currently the rapper “Crip” 65 is presenting with 43 seconds left. In this simple illustration, the list of rappers is cycled through and repeated with each logged on user rapping. Alternatively, as each participant's turn is reached, a dialog 66 may offer the participant the opportunity to select through the mouse pointer (not shown) to rap 67 or just to listen, and thus be a spectator. Currently, Crip 65 is rapping. His image 68 is displayed. There is a volume control 50. Crip's name 31, and ID 32 are listed. On the possibility that an entertainment agent or manager may be impressed with Crip's talent and need more information, Crip has previously entered his profile into the database that may be obtained by selecting button 33. Primarily, for esthetics, there may be displayed a graphic profile 70 of the audio presentation being created. Also, ancillary to this invention, and not part of it, the session may provide a messaging board 72 in which the participants may enter 73 and send 74 messages to each other.

FIG. 4 displays a rap session like that of FIG. 3 except there is a comparison or competition between rappers: Crip 88 again and Investor 98. From the menu of possible rap session rooms 81, the users have selected “East Coast Baby” 82 (shown highlighted), and the “East Cost Baby” that is a competitive rap session with another rapper, “Investor” 98. In the session, everyone who logs on is given an opportunity to rap, i.e. sing or speak an audio input, in conjunction with a rap beat that is played for the rapper. In the session, each rapper who logs on is listed 64, and given an opportunity to rap for a set amount of time (in the illustration, one minute) that is tracked in time window 89. Here, the session permits the two competitors Crip 88 and Investor 98 to compete. Primarily, for esthetics, there may be displayed a graphic profile 90 of the audio presentation being created by each of the rappers. Each of the participants is prompted to vote. In the present case, in prompt window 95, a given spectator has awarded 8.5 points 93 out of a possible 10 points to Investor 98 and 3.5 points 94 out of a possible 10 points to Crip. In windows 96 and 97, respectively, associated with rappers Investor 98 and Crip 88, the totals of the points awarded by all of the participants are tracked. Since current voting participant appears to be the first vote, the values in windows 93 and 94 correspond to the total values respectively in windows 96 and 97.

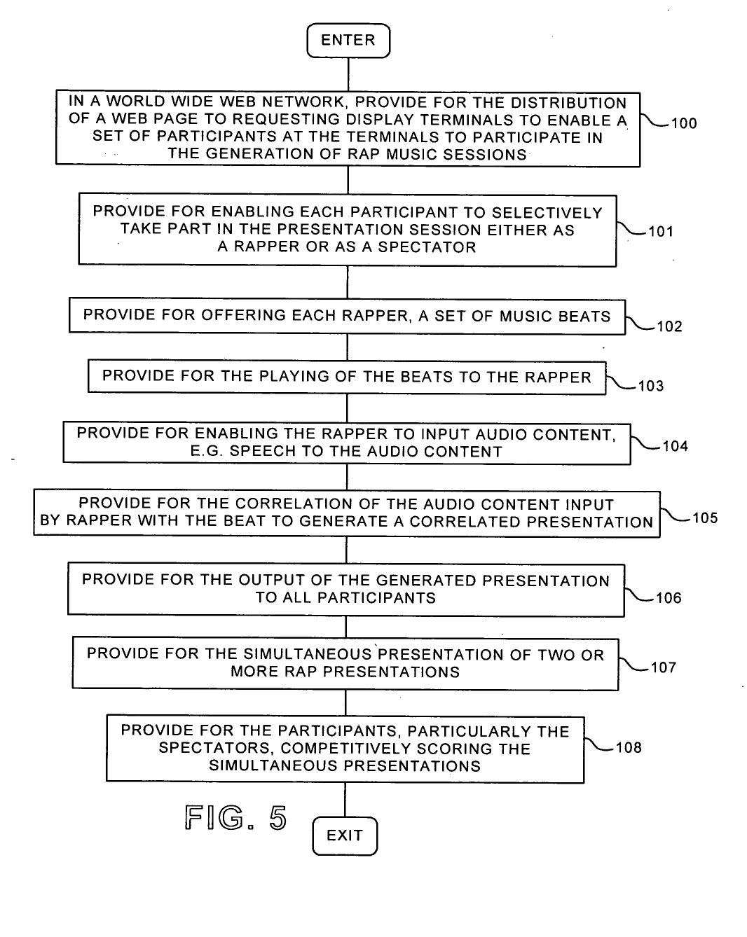

FIG. 5 is a flowchart showing the development of a process according to the present invention for a set of participants at interactive display terminals on the Web to participate in the generation of rap audio presentations in accordance with this invention. Step 100: in a Web network, provision is made for the distribution of the rap session Web page to enable a set of participants at requesting display stations or terminals to participate in the generation of rap music sessions. Provision is made for enabling each participant to selectively take part in the presentation session either as a rapper or as a spectator, step 101. Provision is made for offering each rapper a set of rap music beats, step 102, and further provision is made for playing such beats to the potential rapper, step 103. Provision is made for enabling the rapper to input his own audio content, e.g. speech added to the provided content, step 104. Provision is made for the correlation of the audio content input by the rapper with the beat to generate a correlated rap presentation, step 105. Provision is then made for the output of the correlated generated presentation to all of the participants, both presenters and spectators, step 106. Provision is made for the simultaneous presentation of two (FIG. 4) or more rap presentations, step 107. Finally, provision may be made for all participants, and particularly the spectators to competitively score the simultaneous presentations, step 108.

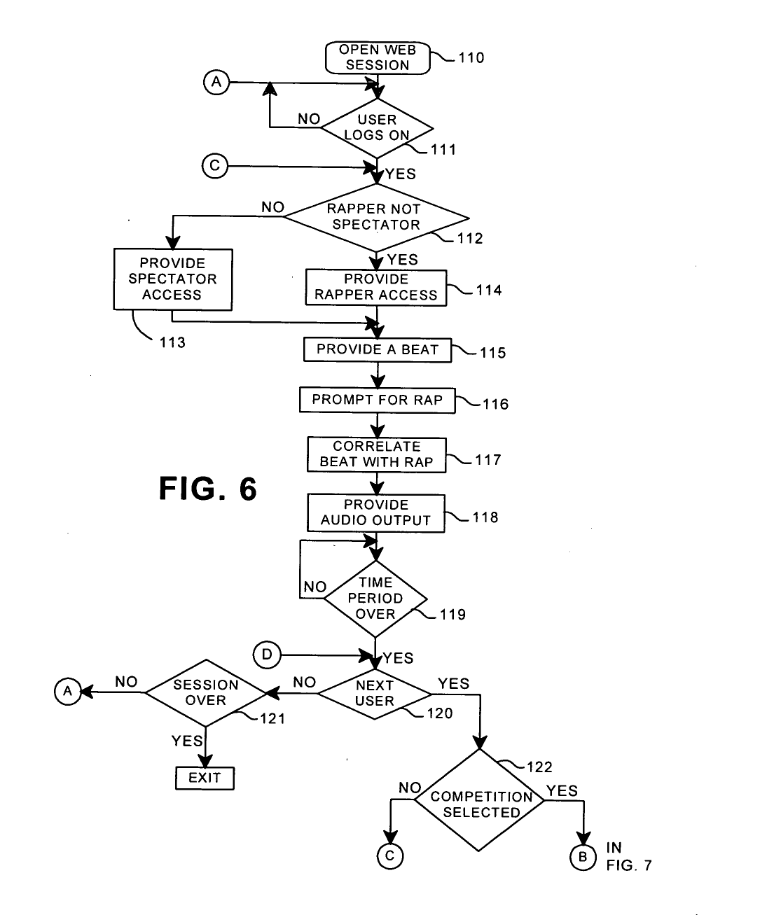

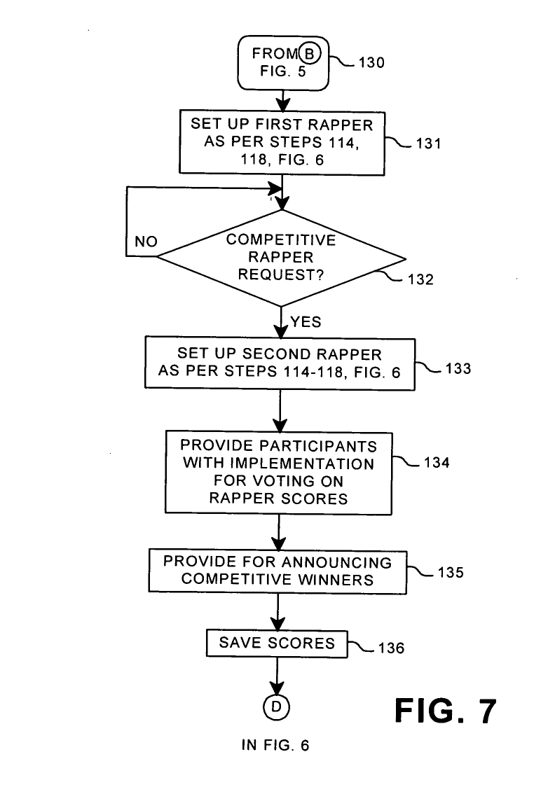

A simplified run of the process set up in FIG. 5 and described in connection with FIGS. 3 and 4 will now be described with respect to the flowcharts of FIGS. 6 and 7. A Web session for rap generation is opened, step 110. A determination is made as to whether a user has logged on, step 111. If Yes, a further determination is made as to whether the log on is by a potential rapper rather than a spectator, step 112. If No, i.e. not a rapper, then spectator access to the Web page is provided, step 113. If Yes, there is a potential rapper, then rapper access is provided, step 114. Then, or after step 113, any rapper is provided a beat, step 115, and the window prompts for rap input, step 116. The rap input is correlated with the beat, step 117. Provision is made for audio output of the correlated rap presentation, 118. As the output continues, a determination is made as to whether the time period accorded to the wrapper is over, step 119. If Yes, a determination is made as to whether there is another user waiting, step 120. If No, a further determination is made as to whether the session may be over, step 121. If the decision in step 121 is Yes, then the session is exited. If No, the session is returned to step 111 via branch “A” where the next logon is awaited. However, if the decision in step 120 is Yes, another user is waiting, a further determination is made, step 122, as to whether the next user wants rap competition. If No, then the session is returned to step 112 via branch “C” where a determination is made as to whether the user wishes to be a rapper or a spectator, and then the session continued. If Yes, in step 122, rap competition is selected, then the session branches via “B” to step 130 in FIG. 7. The rapper who selected competition is then set up in accordance with the process of steps 114 to 118 of FIG. 6, step 131, and a further determination is made, step 132, as to whether there is a further competitive request from another rapper. If Yes, this next competitive rapper is also set up in accordance with the process of steps 114 to 118 of FIG. 6, step 133. Then, the participants are provided with an implementation for voting scores based on rapper performance, step 134. Provision is made for announcing the winners, step 135, and the competitive scores are saved, step 136, after which the session is returned via branch “D” to step 120 in FIG. 6.

Although certain preferred embodiments have been shown and described, it will be understood that many changes and modifications may be made therein without departing from the scope and intent of the appended claims.

What is claimed is:

1. In a World Wide Web (Web) network providing a Web page, displayed on a computer controlled receiving display terminal, a system for enabling participants to participate in the user-interactive generation of audio musical presentations comprising:
means for providing a presentation window space in said Web page;
means in said window for offering a set of selectable audio music beats to a participant;
means for playing one of said offered set of audio music beats to a participant;
means enabling said participant to input audio content;
means for correlating said input audio content with said beat to generate a correlated audio presentation; and
means for providing an audio output of said correlated audio presentation.

2. The Web network of claim 1 wherein said audio beats are rap beats, said input audio content is rap content, and said output presentation is a rap presentation.

3. The Web network of claim 2, further including:
a plurality of said receiving display terminals for each of a plurality of respective participants;
means for displaying said Web page including said presentation window space to each of said participants at said display terminals; and
means for enabling each of said participants to selectively participate in said presentation either as a presenter or as a spectator.

4. The Web network of claim 3, further including means enabling a plurality of said rap presenters to present their respective presentations in said presentation window space.

5. The Web network of claim 4 wherein said presentation window space includes a plurality of presentation windows, each of which respectfully includes one of said presentations.

6. The Web network of claim 5 further including means for simultaneously presenting a plurality of said presentations.

7. The Web network of claim 6 further including:
means for enabling participants to designate score value for each of said plurality of presenters wherein each of the presenters; and
means for displaying the total score value for each of said presenters.

8. The Web network of claim 3 further including:
a source on the Web providing said audio beats; and
Internet Protocol Voice Over telecommunication means for transmitting said audio beats to said receiving display stations.

9. In a Web network providing a Web page, displayed on a computer controlled receiving display terminal, a method for enabling participants to participate in the user-interactive generation of audio musical presentations comprising:
providing a presentation window space in said Web page;
offering a set of selectable audio music beats to a participant in said window;
playing one of said offered set of audio music beats to a participant;
enabling said participant to input audio content;
correlating said input audio content with said beat to generate a correlated audio presentation; and
providing an audio output of said correlated audio presentation.

10. The method of claim 9 wherein said audio beats are rap beats, said input audio content is rap content, and said output presentation is a rap presentation.

11. The method of claim 10, further including the steps of:
displaying said Web page including said presentation window space to each of a plurality of said participants at said display terminals on each of a plurality of said respective receiving display terminals; and
enabling each of said participants to selectively participate in said presentation either as a presenter or as a spectator.

12. The method of claim 11, further including the step of enabling a plurality of said rap presenters to present their respective presentations in said presentation window space.

13. The method of claim 12 wherein said presentation window space includes a plurality of presentation windows, each of which respectfully includes one of said presentations.

14. The method of claim 13 further including the step of simultaneously presenting a plurality of said presentations.

15. The method of claim 14 further including the steps of:
enabling participants to designate score value for each of said plurality of presenters wherein each of the presenters; and
displaying the total score value for each of said presenters.

16. The method of claim 11 further including the steps of
providing said audio beats from a source on the Web by transmitting said audio beats to said receiving display stations by Internet Protocol Voice Over telecommunications.

17. A computer program having code recorded on a computer readable medium for enabling participants to participate in the user-interactive generation of audio musical presentations in a Web network providing Web pages, displayed on a computer controlled receiving display terminal comprising:
means for providing a presentation window space in said Web page;
means in said window for offering a set of selectable audio music beats to a participant;
means for playing one of said offered set of audio music beats to a participant;
means enabling said participant to input audio content;
means for correlating said input audio content with said beat to generate a correlated audio presentation; and
means for providing an audio output of said correlated audio presentation.

18. The computer program of claim 17 wherein said audio beats are rap beats, said input audio content is rap content, and said output presentation is a rap presentation.

19. The computer program of claim 18, further including:
a plurality of said receiving display terminals for each of a plurality of respective participants;
means for displaying said Web page including said presentation window space to each of said participants at said display terminals; and
means for enabling each of said participants to selectively participate in said presentation either as a presenter or as a spectator.

20. The computer program of claim 19, further including means enabling a plurality of said rap presenters to present their respective presentations in said presentation window space.

21. The computer program of claim 20 wherein said presentation window space includes a plurality of presentation windows, each of which respectfully includes one of said presentations.

22. The computer program of claim 21 further including means for simultaneously presenting a plurality of said presentations.

23. The computer program of claim 22 further including:
means for enabling participants to designate score values for each of said plurality of; and
means for displaying the total score value for each of said presenters.

24. The computer program of claim 19 further including:
a source on the Web providing said audio beats; and
Internet Protocol Voice telecommunication means for transmitting said audio beats to said receiving display stations.
